(19) United States
(12) Patent Application Publication
(10) Pub. No.: US 2023/0305866 A1
(43) Pub. Date: Sep. 28, 2023

(54) IMAGE FORMING APPARATUS AND CONTROL METHOD

(71) Applicant: TOSHIBA TEC KABUSHIKI KAISHA, Tokyo (JP)

(72) Inventors: Masato SEKINE, Bunkyo Tokyo (JP); Hiroshi WATANABE, Yokohama Kanagawa (JP); Sho SAKUMA, Sunto Shizuoka (JP); Hironori KUDO, Numazu Shizuoka (JP); Yumi NISHIMORI, Mishima Shizuoka (JP)

(73) Assignee: TOSHIBA TEC KABUSHIKI KAISHA, Tokyo (JP)

(21) Appl. No.: 17/704,768

(22) Filed: Mar. 25, 2022

(51) Int. Cl. G06F 9/451; H04N 1/00

(52) U.S. Cl. CPC G06F 9/453; H04N 1/00488; H04N 1/00395; H04N 1/00424; H04N 1/00482

(57) ABSTRACT

An image forming apparatus includes a display, a detector, and a controller. The display communicates a setting screen for setting a function of the image forming apparatus. The detector detects an operation of a user that the user executes on the setting screen. The controller is configured to communicate guidance regarding the setting screen based on the operation detected by the detector. For example, such guidance may be communicated when the number of operation times of the operation executed by the user on the setting screen exceeds a first threshold and the number of execution times of the function executed by the user previously is less than a second threshold.

### FIELD

Embodiments described herein relate generally to an image forming apparatus and a control method.

### BACKGROUND

An image forming apparatus has a function of providing guidance on various settings of the image forming apparatus. Regarding existing image forming apparatuses, sometimes guidance is uniformly provided for a user who already knows certain functions of an image forming apparatus or a user who does not know such functions at all, or the like. That is, it is hard to say that guidance is provided appropriately in the image forming apparatuses in the related art.

Provided is a technique capable of appropriately providing guidance on various settings of an image forming apparatus.

### DESCRIPTION OF THE DRAWINGS

FIG. 1 is an external view illustrating an overall configuration example of an image forming apparatus 100 according to an embodiment;

FIG. 2 is a diagram illustrating a configuration of a control system;

FIG. 3 is a diagram illustrating a user database;

FIG. 4 is a diagram illustrating a threshold database;

FIG. 5 is a diagram illustrating a screen database;

FIG. 6 is a diagram illustrating an example of a copy function setting screen;

FIG. 7 is a diagram illustrating an example of a guidance screen;

FIG. 8 is a diagram illustrating a threshold setting screen;

FIG. 9 is a flowchart illustrating a flow of guidance processing; and

FIG. 10 is the flowchart illustrating the flow of guidance processing.

### DETAILED DESCRIPTION

According to an embodiment, an image forming apparatus includes a display, a detector, and a controller. The display (or display unit) displays a setting screen related to function setting of the image forming apparatus. The detector (or detection unit) detects an operation of a user on the setting screen displayed by the display unit. The controller (or control unit) communicates an instruction (or guidance) related to the setting screen based on an operation detected by the detection unit when the number of operation times of a specific operation executed by the user on the setting screen related to the execution setting of at least one function (e.g., one function or more than one function) exceeds a first threshold and the number of execution times of the at least one function executed by the user in the past is less than a second threshold.

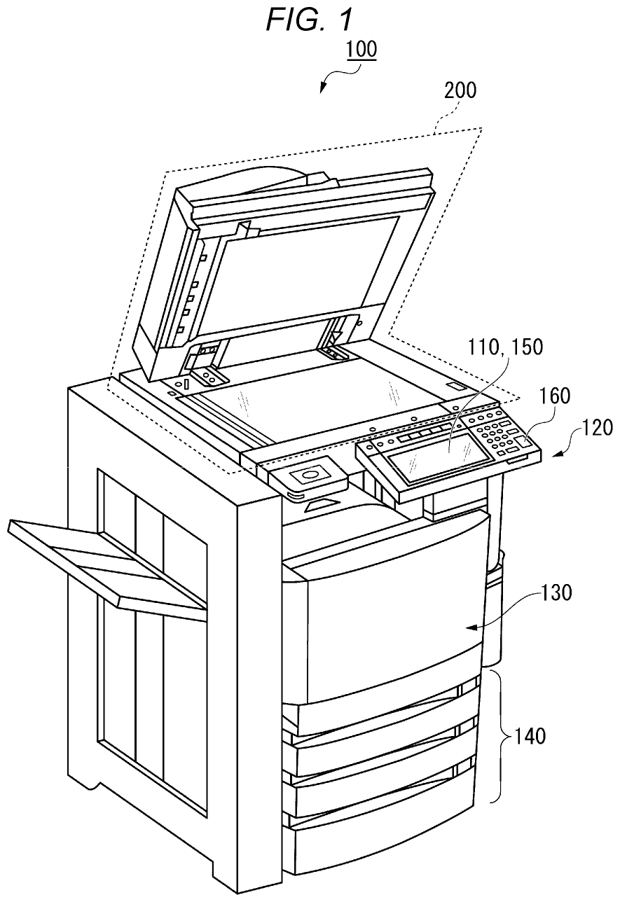

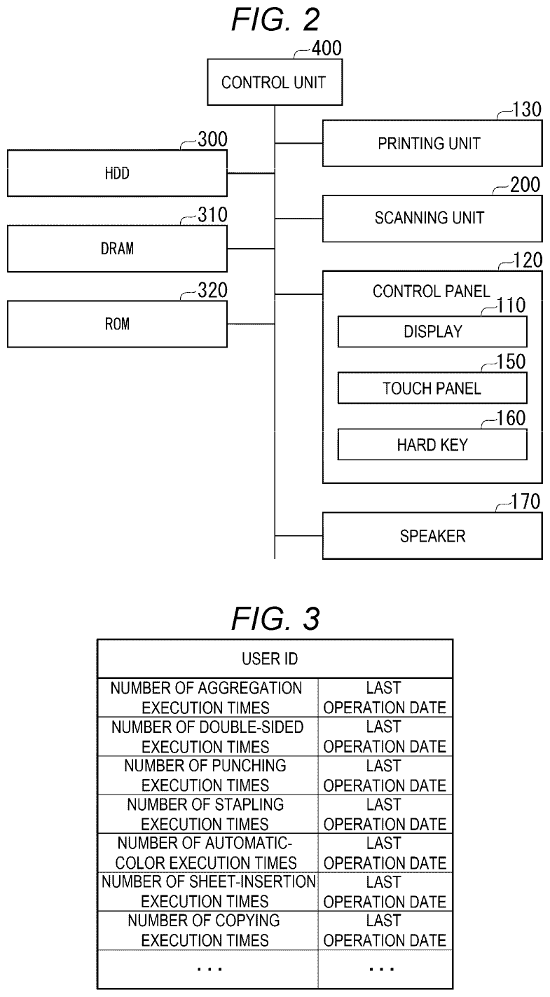

FIG. 1 is an external view illustrating an overall configuration example of an image forming apparatus 100 according to an embodiment. The image forming apparatus 100 is, for example, a multifunction apparatus. The image forming apparatus 100 includes a control panel 120, a printing unit 130, a sheet storage unit 140, and a scanning unit 200. As illustrated in FIG. 2, the image forming apparatus 100 includes a control unit 400 configured to control the entire apparatus. The control panel 120 includes a display 110, a touch panel 150, and a hard key 160.

The image forming apparatus 100 forms an image on a sheet using a developer. The developer is, for example, a toner. In the following description, the developer will be described as a toner. The sheet is, for example, paper or label paper. The sheet may be any sheet as long as the image forming apparatus 100 can form an image on a surface thereof.

The display 110 is an image display device, such as a liquid crystal display or an organic electroluminescence (EL) display. The display 110 is an example of the display unit configured to display various information related to the image forming apparatus 100. The display 110 and the touch panel 150 are integrally formed. The hard key 160 includes a plurality of buttons. The touch panel 150 and the hard key 160 receive an operation of the user. The control panel 120 outputs a signal corresponding to the operation performed by the user to the control unit 400 of the image forming apparatus 100. The control panel 120 is an example of the detection unit configured to detect an operation of the user on the setting screen. The “operation of the user on the setting screen” indicates at least one of an operation of the user on the touch panel 150 and an operation of the user on the hard key 160.

The printing unit 130 prints an image on a sheet based on image information generated by the scanning unit 200 or image information received via a network. The printing unit 130 prints the image using the toner. The sheet printed with the image may be a sheet stored in the sheet storage unit 140 or a manually provided sheet. The sheet storage unit 140 stores sheets used for image formation in the printing unit 130.

The scanning unit 200 reads image information to be read as brightness and darkness of light. The scanning unit 200 records the read image information. The recorded image information may be transmitted to other information processing devices via the network. The recorded image information may become an image formed on a sheet by the printing unit 130.

FIG. 2 is a diagram illustrating a configuration of a control system of the image forming apparatus 100. The image forming apparatus 100 includes the printing unit 130, the scanning unit 200, the control panel 120, a speaker 170, the control unit 400, a hard disk drive (HDD) 300, a dynamic random access memory (DRAM) 310, and a read only memory (ROM) 320. These units are connected to each other via a system bus.

The control unit 400 controls all the units connected via the system bus. The ROM 320 stores various control programs necessary for the operation of the image forming apparatus 100. The ROM 320 stores the programs for controlling an image forming operation and the like. The HDD 300 stores programs and data. The control unit 400 controls execution of each program stored in the ROM 320 and the HDD 300. The DRAM 310 is a buffer memory configured to temporarily store data generated when each program is executed. The speaker 170 is an example of an audio output unit (or an audio output transceiver). The speaker 170 outputs audio guidance related to the setting screen and outputs operation sounds (or operation audio signals), error sounds (or error audio signals), or the like in accordance with control of the control unit 400.

Next, a configuration and guidance processing of appropriately providing guidance on various settings of the image forming apparatus 100 will be described. FIG. 3 is a diagram illustrating a user database. The user database is stored in the HDD 300. The user database is provided for each user. The user database includes a user ID, the number of execution times of functions of the image forming apparatus 100 executed by the user, and dates of last operations performed by the user for executing the functions.

Among these, the user ID is data for uniquely identifying a user. Each of the functions is a function of the image forming apparatus, and as an example, FIG. 3 illustrates functions of aggregation, duplexing, punching, stapling, automatic color, sheet insertion, and copying. The aggregation indicates a function of aggregately printing a plurality of pages on one sheet. The duplexing indicates a double-sided copy function. The punching indicates a function of forming a hole in a printed sheet. The stapling indicates a function of binding printed sheets. The automatic color indicates a function of automatic color printing when a document is a color document. The sheet insertion indicates a function of inserting a special sheet such as colored paper or thick paper into printed sheets. The copying indicates a copy function. As indicated by the copy function and the double-sided copy function, the number of execution times of a function including other functions may also be recorded in the database.

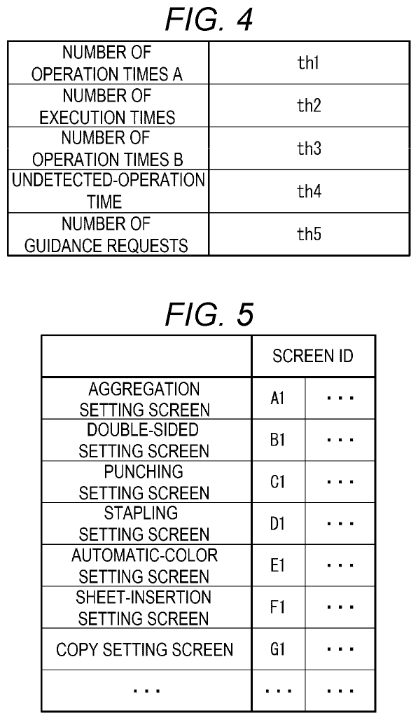

FIG. 4 is a diagram illustrating a threshold database. The threshold database is stored in the HDD 300. The threshold database includes a threshold th1 for the number of operation times A, a threshold th2 for the number of execution times, a threshold th3 for the number of operation times B, a threshold th4 for an undetected-operation time, and a threshold th5 for the number of guidance requests.

The threshold th1 of the number of operation times A refers to a threshold for comparison with the number of operation times of a specific operation performed by the user on the setting screen related to the execution setting of one function. The threshold th1 is an example of the first threshold. The specific operation refers to an operation of displaying a setting screen corresponding to each function. The number of operation times is counted for each function. For example, when a copy setting screen is displayed three times, the number of operation times is three, and when a scanner setting screen is displayed once, the number of operation times is one.

The threshold th2 of the number of execution times refers to a threshold for comparison with the number of execution times of each function as illustrated in FIG. 3. The threshold th2 is an example of the second threshold. The threshold th3 of the number of operation times B refers to a threshold for comparison with the number of operation times of a specific operation performed by the user on the setting screen related to the execution setting of one function. The threshold th3 is an example of a third threshold.

The threshold th4 of the undetected-operation time refers to a threshold for comparison with a time during which no operation is detected by the control panel 120. The threshold th4 is an example of a fourth threshold. The threshold th5 of the number of guidance requests refers to a threshold for comparison with the number of operation times of an operator (or interface) to be described later, which is provided on the setting screen for outputting audio guidance in response to an operation of the user. The threshold th5 is an example of a fifth threshold.

FIG. 5 is a diagram illustrating a screen database. The screen database is stored in the HDD 300. The screen database is a database indicating setting screens corresponding to the functions respectively. The screen database includes screen IDs indicating the screens corresponding to the functions respectively. For example, a setting screen corresponding to the aggregation includes a setting screen having a screen ID of A1. When there are N aggregation setting screens, screen IDs A1 to AN are provided. The number of setting screens such as N is not a uniform value since the number of setting screens is different for each function. The control unit 400 uses the screen IDs to specify a currently displayed screen so as to be able to determine that an operation corresponding to which function is performed.

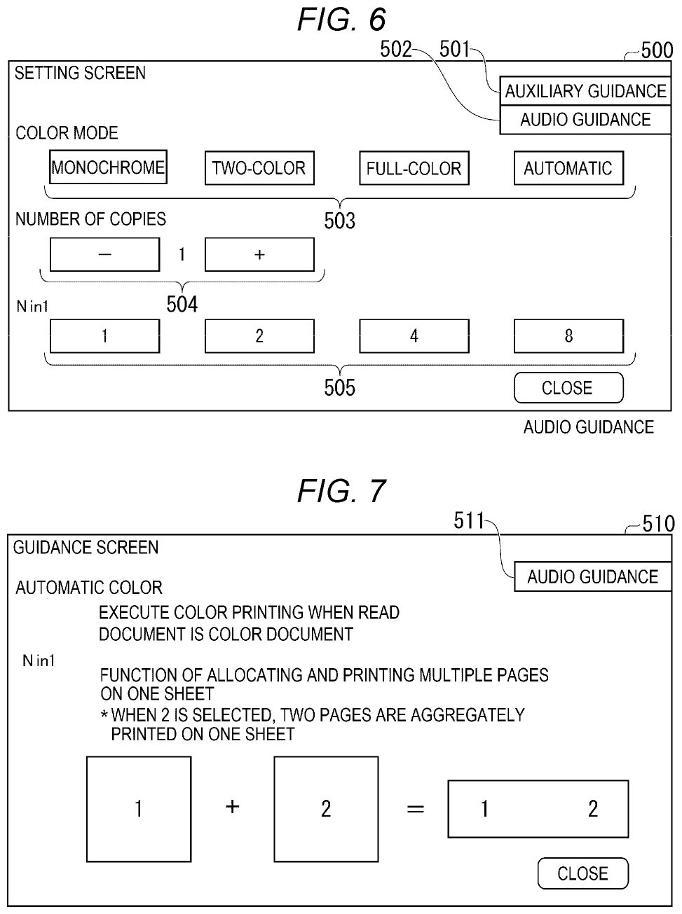

Next, an example of a setting screen will be described. FIG. 6 is a diagram illustrating an example of a copy function setting screen. As an example, an auxiliary guidance button 501, an audio guidance button 502, a color-mode setting button group 503, a copy number setting button group 504, and an Nin1 setting button group 505 are displayed on a setting screen 500. The audio guidance button 502 is an example of the operator (or interface) described above.

The auxiliary guidance button 501 is a button for displaying guidance related to the setting screen 500. The audio guidance button 502 is a button for providing audio guidance. When the audio guidance button 502 is operated, audio guidance related to the setting screen 500 is output.

The color-mode setting button group 503 includes buttons for setting color modes. The buttons for setting the color modes include “monochrome”, “two-color”, “full-color”, and “automatic”. The copy number setting button group 504 includes buttons for setting the number of copies to be printed. The copy number setting button group 504 includes a “+” button for increasing the number of copies and a “−” button for decreasing the number of copies. The Nin1 setting button group 505 includes buttons each for setting an aggregation number in aggregation. The Nin1 setting button group 505 includes buttons of “1”, “2”, “4”, and “8”. Each numerical value indicates an aggregation number.

FIG. 7 is a diagram illustrating an example of a guidance screen. As illustrated in FIG. 7, a guidance screen 510 indicates a screen displayed when the auxiliary guidance button 501 of the setting screen 500 is operated. The guidance screen 510 displays guidance related to the settings (automatic and Nin1) displayed on the setting screen 500. The guidance screen 510 is also provided with an audio guidance button 511. When the audio guidance button 511 is operated, audio guidance related to the guidance screen 510 is output. The guidance screen 510 may be displayed in a pop-up manner.

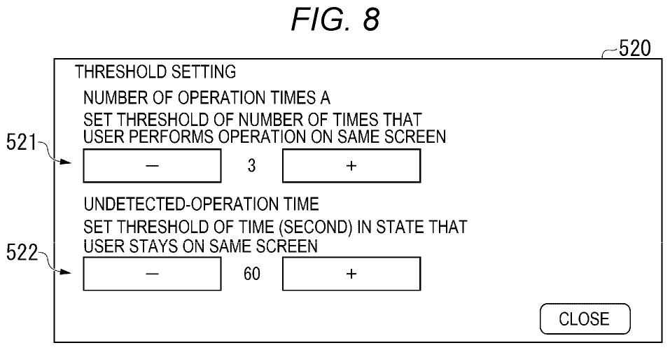

Thresholds described in FIG. 4 can be set. FIG. 8 is a diagram illustrating a threshold setting screen. A threshold setting screen 520 is, for example, a diagram illustrating a setting field 521 for the threshold th1 of the number of operation times A and a setting field 522 for the threshold th4 of the undetected-operation time.

The setting fields 521 and 522 include “+” buttons for increasing the threshold and “−” buttons for decreasing the threshold. In the setting field 521, when the “+” button is operated, the threshold increases from 3 (times) to 4 (times), and when the “−” button is operated, the threshold decreases from 3 (times) to 2 (times). In the setting field 522, when the “+” button is operated, the threshold increases from 60 (seconds) to 61 (seconds), and when the “−” button is operated, the threshold decreases from 60 (seconds) to 59 (seconds).

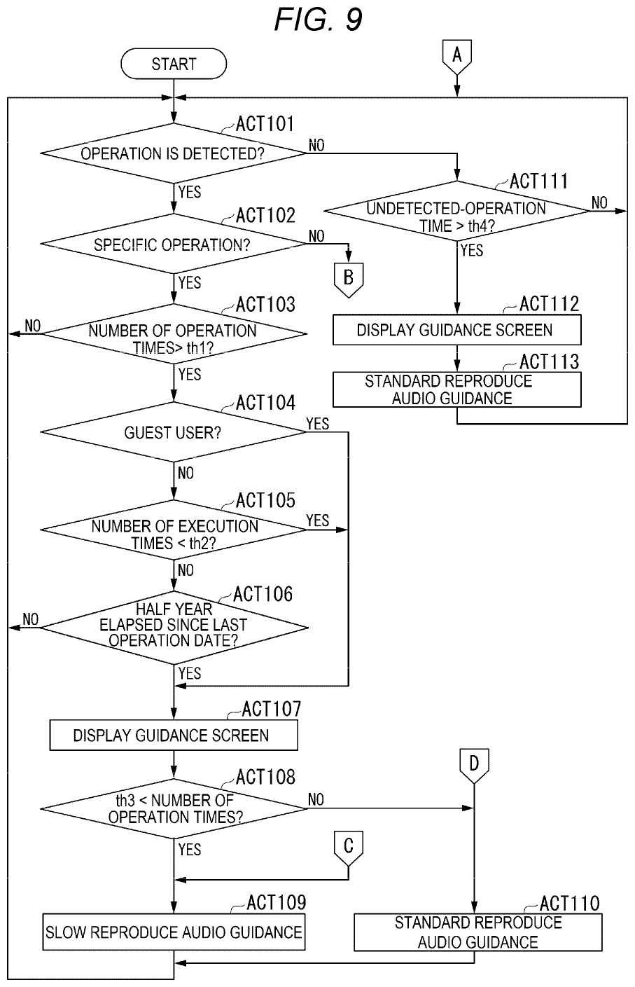

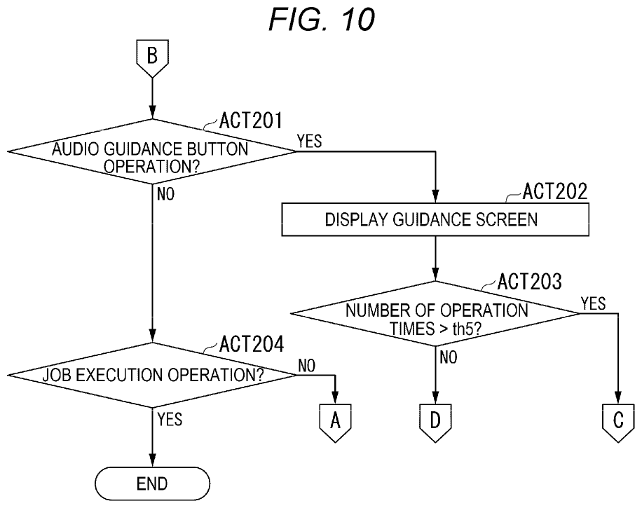

Next, processing of appropriately providing guidance on various settings of the image forming apparatus 100 will be described with reference to a flowchart. FIGS. 9 and 10 are a flowchart illustrating a flow of guidance processing. In this flowchart, the user who is operating the image forming apparatus is assumed to log in the image forming apparatus 100. Therefore, the user identification (ID) was acquired. The user can also log in the image forming apparatus 100 as a guest user, for example, when a user ID is not recognized by the image forming apparatus 100.

In FIG. 9, the control unit 400 determines whether an operation is detected by the control panel 120 (ACT 101). If an operation is detected (ACT 101: YES), the control unit 400 determines whether the detected operation is a specific operation (ACT 102). If the detected operation is not the specific operation (ACT 102: NO), the control unit 400 proceeds to ACT 201 of FIG. 10 to be described later.

If the detected operation is the specific operation (ACT 102: YES), the control unit 400 determines whether the number of operation times performed on the currently displayed setting screen exceeds the threshold th1 (ACT 103). If the number of operation times is equal to or smaller than the threshold th1 (ACT 103: NO), the control unit 400 returns to ACT 101.

If the number of operation times exceeds the threshold th1 (ACT 103: YES), the control unit 400 determines whether the user who is currently performing an operation is a guest user (ACT 104). If the user who is currently performing an operation is a guest user (ACT 104: YES), the control unit 400 outputs the guidance screen to the display 110 to display the guidance screen (ACT 107). As described above, if the user is a guest user, the guidance related to the setting screen is output regardless of the number of execution times of one function executed by the guest user in the past when the number of operation times exceeds the threshold th1. In this manner, according to the embodiment, the guidance screen can be flexibly displayed for the guest user as well.

In ACT 104, when the user who is currently performing an operation is not a guest user (ACT 104: NO), the control unit 400 refers to the user database and acquires the number of execution times of the function corresponding to a screen ID of the currently displayed screen. The control unit 400 determines whether the acquired number of execution times is smaller than the threshold th2 (ACT 105). If the acquired number of execution times is smaller than the threshold th2 (ACT 105: YES), the control unit 400 outputs the guidance screen to the display 110 to display the guidance screen (ACT 107).

As described above, based on the operation detected by the control panel 120, the control unit 400 outputs the guidance related to the setting screen when a following condition is satisfied with respect to the setting screen related to the execution setting of one function by the user. The condition refers to a condition that the number of operation times of a specific operation exceeds the threshold th1 and the number of execution times of one function executed by the user in the past is smaller than the threshold th2. In this manner, according to the embodiment, since the user who is familiar with the function is not provided with the guidance related to the setting, the user does not feel bothersome. Guidance on various settings can be appropriately provided. On the other hand, according to the embodiment, since a user who is not familiar with the function is provided with the guidance related to the setting, guidance on various settings can be appropriately provided.

In ACT 105, when the acquired number of execution times is equal to or greater than the threshold th2 (ACT 105: NO), the control unit 400 refers to the user database and acquires a last operation date of the function corresponding to the screen ID of the currently displayed screen. The control unit 400 determines whether half a year or more elapsed since the acquired last operation date (ACT 106). Here, as an example, a predetermined period is set as half a year since the last operation date and may be set for each user; when a function requires complicated operations (e.g., five or more operations necessary for the setting), the predetermined period may be set as a shorter period than that in a non-complicated operation.

If half a year or more did not elapse since the last operation date (ACT 106: NO), the control unit 400 returns to ACT 101. If half a year or more elapsed since the last operation date (ACT 106: YES), the control unit 400 displays the guidance screen by outputting the guidance screen to the display 110 (ACT 107).

As described above, even when the number of operation times exceeds the threshold th1 and the number of execution times of one function executed by the user in the past is equal to or greater than the threshold th2, the control unit 400 outputs the guidance related to the setting screen when the predetermined period elapsed since last execution of one function by the user. When a relatively long period elapsed since the last operation date, there is a high possibility that the user will forget the information related to the setting. Therefore, according to the embodiment, guidance on various settings can be appropriately provided.

After the guidance screen is displayed in ACT 107, the control unit 400 determines whether the number of operation times exceeds the threshold th3 (ACT 108). If the number of operation times does not exceed the threshold th3 (ACT 108: NO), the control unit 400 performs standard reproduction on audio guidance (ACT 110), and returns to ACT 101. On the other hand, if the number of operation times exceeds the threshold th3 (ACT 108: YES), the control unit 400 performs slow reproduction on the audio guidance (ACT 109), and returns to ACT 101.

As described above, when the number of operation times exceeds the threshold th3 greater than the threshold th1, the control unit 400 performs the following control. That is, the control unit 400 outputs guidance to the speaker 170 as sound at a slower speed (slow reproduction) as compared with a reading speed (standard reproduction) of sounds to be output when the number of operation times is greater than the threshold th1 and equal to or smaller than the threshold th3. A fact that the number of operation times exceeds the threshold th3 greater than the threshold th1 indicates that the user opens the same setting screen many times. Therefore, the user can hear the audio guidance more easily by performing slow audio reproduction. Therefore, according to the embodiment, guidance on various settings can be appropriately provided.

In ACT 101, when the operation is not detected (ACT 101: NO), the control unit 400 determines whether the undetected-operation time exceeds the threshold th4 (ACT 111). If the undetected-operation time does not exceed the threshold th4 (ACT 111: NO), the control unit 400 returns to ACT 101. On the other hand, if the undetected-operation time exceeds the threshold th4 (ACT 111: YES), the control unit 400 displays the guidance scree by outputting the guidance screen corresponding to the currently displayed setting screen to the display 110 (ACT 112). In addition, the control unit 400 outputs the audio guidance corresponding to the currently displayed setting screen to the speaker 170 (ACT 113), and returns to ACT 101.

When no operation is performed for a relatively long time in a state where the same screen is opened, there is a high possibility that the user is unfamiliar with the operation. Therefore, according to the embodiment, guidance on various settings can be appropriately provided.

In ACT 102, when the detected operation is not the specific operation (ACT 102: NO), the control unit 400 proceeds to ACT 201 in FIG. 10. The control unit 400 determines whether the detected operation is an audio guidance button operation (ACT 201). If the detected operation is the audio guidance button operation (ACT 201: YES), the control unit 400 displays the guidance screen by outputting the guidance screen corresponding to the currently displayed setting screen to the display 110 (ACT 202). The control unit 400 determines whether the number of operation times of the audio guidance button operation exceeds the threshold th5 (ACT 203).

If the number of operation times does not exceed the threshold th5 (ACT 203: NO), the control unit 400 performs standard reproduction of the audio guidance (ACT 110), and returns to ACT 101. On the other hand, if the number of operation times exceeds the threshold th5 (ACT 203: YES), the control unit 400 performs slow reproduction of the audio guidance (ACT 109), and returns to ACT 101.

As described above, when the number of operation times performed on the audio guidance button exceeds the threshold th5, the control unit 400 outputs the guidance as a sound at a slower speed as compared with the reading speed of sounds to be output when the number of operation times performed on the audio guidance button is equal to or smaller than the threshold th5.

A fact that the number of operation times exceeds the threshold th5 indicates that the user is listening to the same audio guidance many times. Therefore, the user can hear the audio guidance more easily by performing slow audio reproduction. Therefore, according to the embodiment, guidance on various settings can be appropriately provided.

If the detected operation is not the audio guidance button operation (ACT 201: NO), the control unit 400 determines whether the detected operation is a job execution operation (ACT 204). If the detected operation is the job execution operation (ACT 204: YES), it indicates that the setting is completed and the control unit 400 ends the guidance processing. On the other hand, if the detected operation is not the job execution operation (ACT 204: NO), the control unit 400 returns to ACT 101.

As described above, in the embodiment, guidance is output in accordance with the number of times the user displays the same setting screen or the number of times the user executes a function, so that the guidance can be appropriately provided. According to the embodiment, since the audio guidance is slowly reproduced, the user can hear the audio guidance more easily. When slow reproduction is performed, the control unit 400 may increase a volume.

As described above, according to the image forming apparatus 100 in the embodiment, a technique capable of appropriately providing guidance on various settings of the image forming apparatus 100 can be provided.

As contents to be particularly displayed on the guidance screen, contents related to unique names of the image forming apparatus 100 (e.g., names used only by a manufacturer of the image forming apparatus) are exemplified.

While certain embodiments have been described, these embodiments have been presented by way of example only, and are not intended to limit the scope of the inventions. These embodiments may be embodied in a variety of other forms. Furthermore, various omissions, substitutions, and changes may be made without departing from the spirit of the inventions. These embodiments and the modifications thereof fall within the scope and spirit of the invention and are included in the scope of the invention recited in the claims and the equivalent thereof.

1. An image forming apparatus comprising:
a display configured to display a setting screen allowing setting a function of the image forming apparatus;
a control unit configured to:
detect an operation of a user executed on the setting screen in response to the setting screen being displayed by the display;
communicate first guidance regarding the setting screen based on the operation detected by the control unit in response to a number of operation times of the operation executed by the user on the setting screen, relating to setting of the function, exceeding a first threshold and a number of execution times of the function executed by the user previously is less than a second threshold; and
communicate second guidance regarding the setting screen in response to a time during which the operation is not detected by the control unit exceeding a third threshold.

2. The apparatus according to claim 1, further comprising:
an audio output transceiver configured to communicate an audio signal,
wherein the control unit is configured to communicate with the audio output transceiver to cause the first guidance to be output as the audio signal.

3. The apparatus according to claim 2, wherein
in response to the number of operation times exceeding the third threshold greater than the first threshold, the control unit communicates the first guidance audibly at a slower speed as compared with a reading speed of the first guidance to be communicated audibly in response to the number of operation times being greater than the first threshold and equal to or less than the third threshold.

4. The apparatus according to claim 1, wherein
the control unit is configured to communicate the first guidance as visual guidance communicated on the display.

5. (canceled)

6. The apparatus according to claim 1, wherein
in response to the number of operation times exceeding the first threshold and the number of execution times of the function executed by the user previously is equal to or greater than the second threshold, the control unit communicates the first guidance regarding the setting screen in response to a predetermined period elapsing from a last time in response to the user executing the function.

7. The apparatus according to claim 2, wherein
at least a portion of the display provided with the setting screen is configured to allow audio guidance to be communicated in response to the operation executed by the user, and in response to the number of operation times that are executed exceeding the third threshold, the first guidance is communicated as an audio signal at a slower speed as compared with a reading speed of an audio signal, which is communicated in response to the number of operation times executed being equal to or less than the third threshold.

8. The apparatus according to claim 1, wherein
in response to the user being a guest user and in response to the number of operation times exceeding the first threshold, the control unit communicates the first guidance regarding the setting screen regardless of the number of execution times that the guest user executed the function previously.

9. A controlling method for an image forming apparatus, the controlling method comprising:
displaying a setting screen allowing setting a function of the image forming apparatus;
detecting an operation of a user executed on the setting screen in response to the setting screen being displayed by a display;
communicating first guidance regarding the setting screen based on the operation detected by a control unit in response to a number of operation times of the operation executed by the user on the setting screen, relating to setting of the function, exceeding a first threshold and a number of execution times of the function executed by the user previously is less than a second threshold; and
communicating second guidance regarding the setting screen in response to a time during which the operation is not detected exceeding a third threshold.

10. The controlling method according to claim 9, wherein the first guidance is communicated as an audio signal by an audio output transceiver.

11. The controlling method according to claim 10, wherein
the control unit causes communication of the first guidance audibly in response to the number of operation times exceeding the third threshold greater than the first threshold at a slower speed as compared with a reading speed of the first guidance to be communicated audibly in response to the number of operation times being greater than the first threshold and equal to or less than the third threshold.

12. The controlling method according to claim 9, wherein the control unit causes communication of the first guidance as visual guidance shown on the display.

13. (canceled)

14. The controlling method according to claim 9, wherein
in response to the number of operation times exceeding the first threshold and the number of execution times of the function executed by the user previously is equal to or greater than the second threshold, the control unit communicates the first guidance regarding the setting screen in response to a predetermined period elapsing from a last time in response to the user executing the function.

15. The controlling method according to claim 10, wherein
the first guidance is communicated audibly via at least a portion of the setting screen in response to the operation executed by the user, and in response to the number of operation times that are executed exceeding the third threshold, the first guidance is communicated as an audio signal at a slower speed as compared with a reading speed of an audio signal, which is communicated in response to the number of operation times executed being equal to or less than the third threshold.

16. The controlling method according to claim 9, wherein
in response to the user being a guest user and in response to the number of operation times exceeding the first threshold, the control unit communicates the first guidance regarding the setting screen regardless of the number of times that the guest user executed the function previously.
